(19) United States
(12) Patent Application Publication
(10) Pub. No.: US 2016/0321600 A1
(43) Pub. Date: Nov. 3, 2016

(54) SELF SERVICE TERMINAL

(71) Applicant: ADI ABUTBUL, BEER SHEVA (IL)

(72) Inventor: ADI ABUTBUL, BEER SHEVA (IL)

(21) Appl. No.: 15/065,926

(22) Filed: Mar. 10, 2016

Related U.S. Application Data
(60) Provisional application No. 62/153,527, filed on Apr. 28, 2015.

(51) Int. Cl. G06Q 10/08; G06Q 20/18

(52) U.S. Cl. CPC G06Q 10/083; G06Q 20/18

(57) ABSTRACT

A self-service terminal, including a platform, for placing an item thereon for delivery, a user interface, for inputting delivery data, at least one sensor and a computer, for reading and analyzing the item, self-payment means, for allowing paying according to determination of the computer; and a conveyor, for transferring the item from the platform for delivery, upon making the payment.

### CROSS-REFERENCE TO RELATED APPLICATIONS

This application claims the benefit of priority from U.S. Provisional Patent Application No. 62/153,527 filed Apr. 28, 2015, the disclosure of which is incorporated herein by reference.

### TECHNICAL FIELD

The invention relates to the field of self service terminals. More particularly, the invention relates to a method and apparatus for delivery.

### BACKGROUND

Sending a package is done at the post office. People are standing and waiting a long time for their turn. They should come to the post offices only on the work hours for doing these actions.

This approach requires manpower and therefore packages' treatment costs are expensive.

The invention provides a solution to the above-mentioned and other problems of the prior art.

### SUMMARY

In one aspect, the invention is directed to a self-service terminal, including:
a platform, for placing an item thereon for delivery;
a user interface, for inputting delivery data;
at least one sensor and a computer, for reading and analyzing the item;
self-payment means, for allowing paying according to determination of the computer; and
a conveyor, for transferring the item from the platform for delivery, upon making the payment.

### BRIEF DESCRIPTION OF THE DRAWINGS

Embodiments, features, and aspects of the invention are described herein in conjunction with the following drawings:

FIG. 1 depicts a shipment terminal according to one embodiment of the invention.

FIG. 2 depicts the shipment terminal of FIG. 1, once opening the cell.

FIG. 3 depicts the third step of the mechanical operation of the shipment terminal of FIG. 1, according to one embodiment.

FIG. 4 depicts the next steps of the mechanical operation of the shipment terminal of FIG. 3.

FIG. 5 depicts the step of accepting the payment of FIG. 2.

FIG. 6 depicts the removal of the shipped item from the conveyor of FIG. 2 to a storage room.

FIG. 7 depicts the next steps of the mechanical operation of the shipment of the other item depicted in FIG. 3.

The drawings are not necessarily drawn to scale.

### DETAILED DESCRIPTION

The invention will be understood from the following detailed description of embodiments of the invention, which are meant to be descriptive and not limiting. For the sake of brevity, some well-known features, methods, systems, procedures, components, circuits, and so on, are not described in detail.

The reference numbers have been used to point out elements in the embodiments described and illustrated herein, in order to facilitate the understanding of the invention. They are meant to be merely illustrative, and not limiting. Also, the foregoing embodiments of the invention have been described and illustrated in conjunction with systems and methods thereof, which are meant to be merely illustrative, and not limiting.

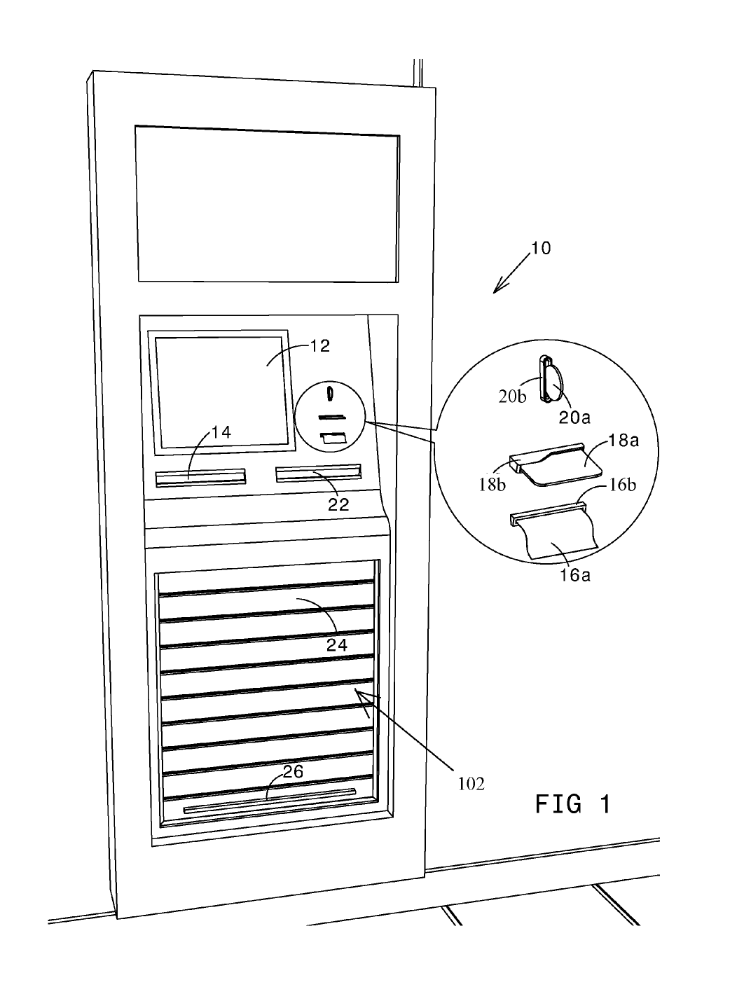

FIG. 1 depicts a shipment terminal according to one embodiment of the invention.

A shipment terminal 10 includes a cell 102.

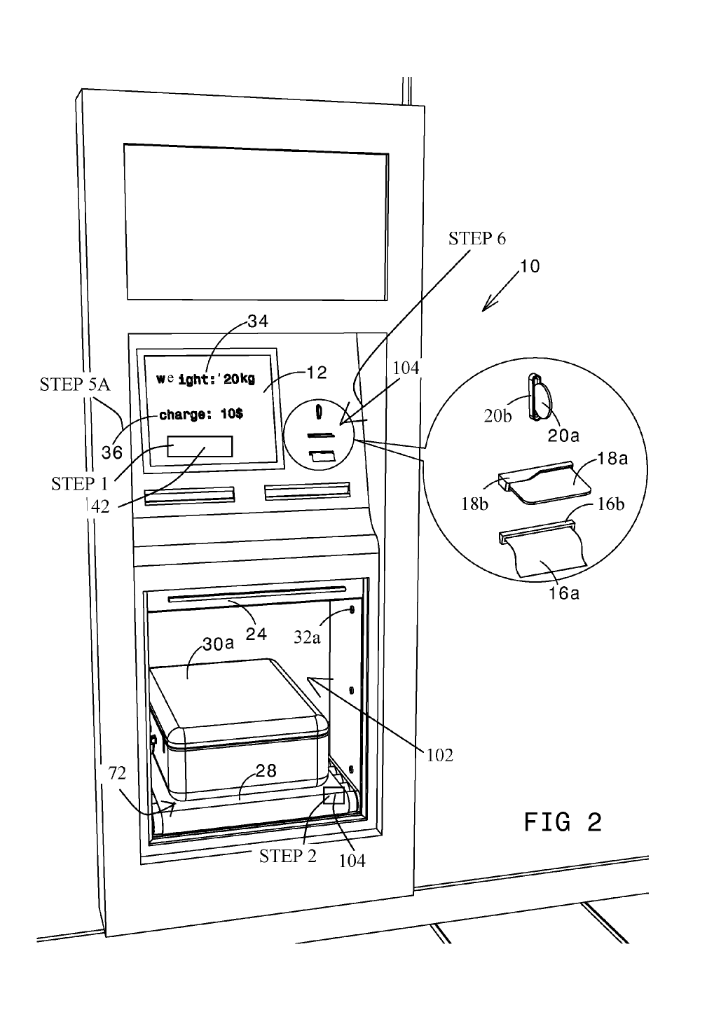

FIG. 2 depicts the shipment terminal of FIG. 1, once opening the cell.

Cell 102 includes a platform for placing therewithin an item 30a, for delivery; a user interface 12, which may constitute a touch screen, for inputting data, such as the delivery address 42; a conveyor 28 including a weight 104, for weighing item 30a, such as displayed by numeral 34 in touch screen 12; and payment means 104, for making the payment.

At the first step, the user provides the delivery data, such as the delivery address 42. At the second step, shipment terminal 10 weighs item 30.

Cell 102 includes scanning cameras 32a, for analyzing the contents of item 30a to be shipped.

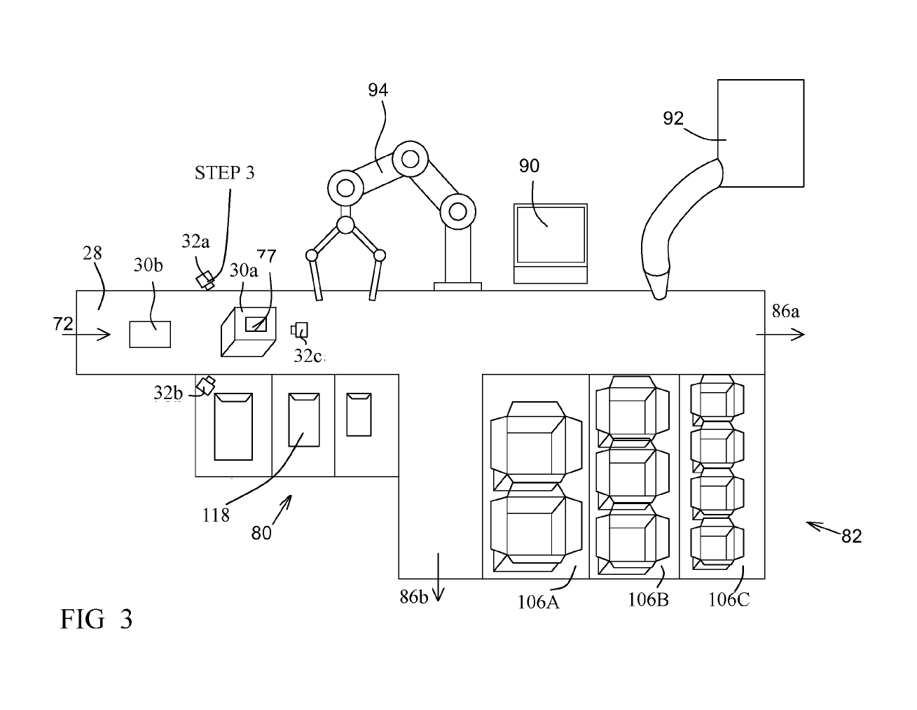

FIG. 3 depicts the third step of the mechanical operation of the shipment terminal of FIG. 1, according to one embodiment.

At the third step, which is upon placing item 30a onto conveyor 28, each of scanners 32a, 32b, and 32c scans item 30a from a different dimension, providing the data to a computer 90.

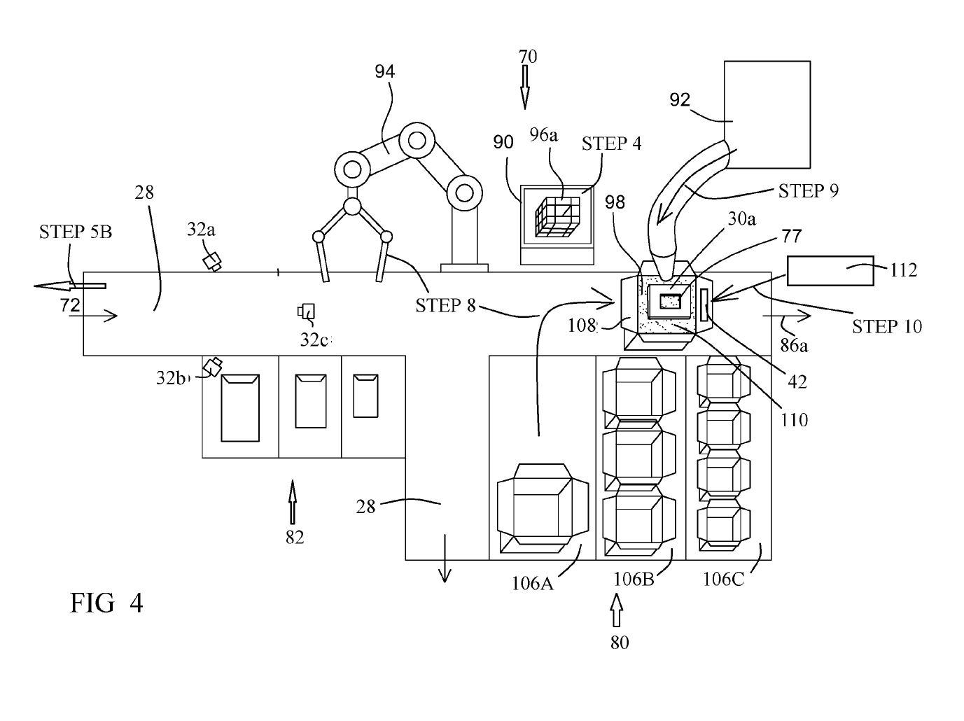

FIG. 4 depicts the next steps of the mechanical operation of the shipment terminal of FIG. 3.

At the fourth step, computer 90 builds the data from scanners 32a, 32b, and 32c to a three-dimensional model 96a of item 30a.

According to the example of item 30a, computer 90 analyzes the three-dimensional model 96a of item 30a, and accordingly selects a packaging type 82, being a carton box packaging, rather than other packaging types, such as packaging type 80, being envelope packaging.

Computer 90 further analyzes the three-dimensional model 96a of item 30a, and accordingly selects the large boxes compartment 106A, rather than medium boxes compartment 106B or small boxes compartment 106C.

According to the example of item 30a, computer 90 further analyzes the three-dimensional model 96a of item 30a, and accordingly finds a gap 77 at the center of item 30a.

Referring again to FIG. 2, at the fifth step according to a first case, denoted “Step 5A”, computer 90 computes the price 36, including of the packaging.

According to another case of the fifth step, denoted “Step 5B”, and referring again to FIG. 4, computer 90 may decide that item 30a cannot be delivered, and thus directs conveyor 28 backwards for not receiving item 30a.

At the sixth step, being further to the first case of the fifth step, denoted “Step 5A”, and referring again to FIG. 1, the user pays, by operating the paying means 104.

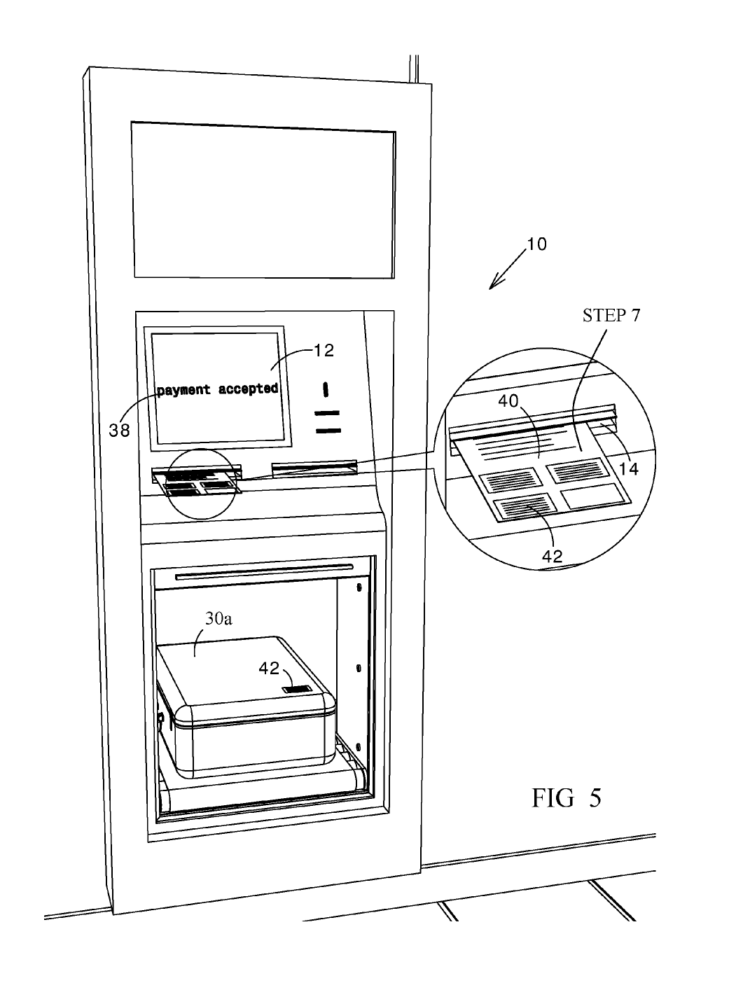

FIG. 5 depicts the step of accepting the payment of FIG. 2.

At the sixth step, delivery terminal 10 accepts the payment, and prints a receipt 40, which preferably includes address 42.

Referring again to FIG. 4, at the eighth step and further, a packaging system 70 packages item 30a, as a function of model 96a.

At the eighth step, a robotic arm 94 removes a carton box 108 from large boxes compartment 106A, and inserts item 30a thereinto.

At the ninth step, since box 108 is slightly larger than item 30a, a polystyrene beads dispenser 92 dispenses polystyrene beads 110 into the gaps between box 108 and item 30a, and into center gap 77.

Further, robotic arm 94 closes box 108.

At the tenth step, a printer 112 prints the delivery address 42 on box 108.

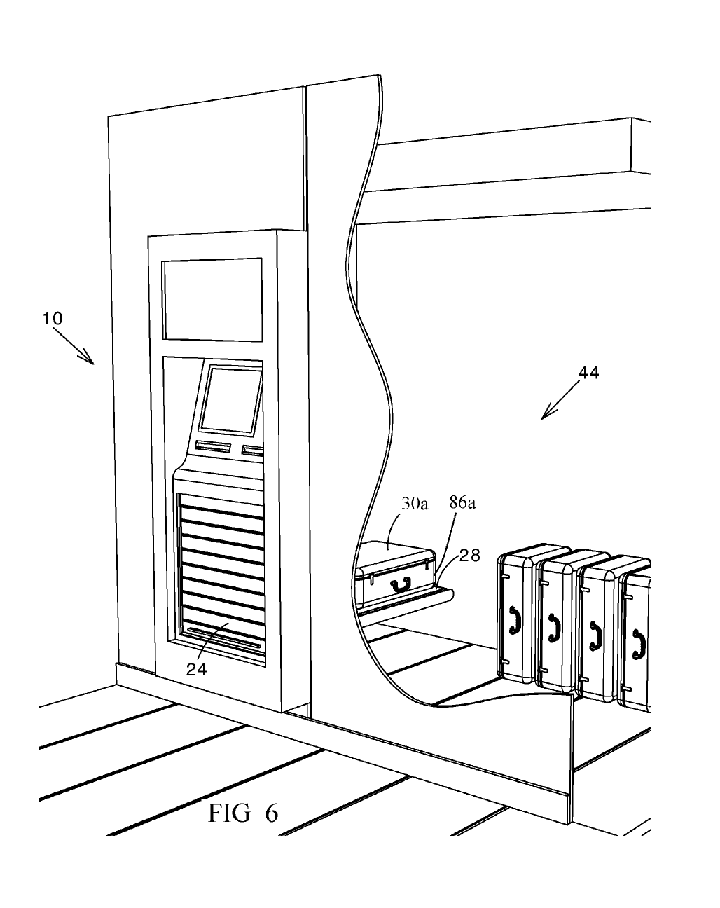

FIG. 6 depicts the removal of the shipped item from the conveyor of FIG. 2 to a storage room.

At the eleventh step, conveyor 28 transfers item 30a to a first exit 86a of conveyor 28 for placing it in a delivery room 44.

Regarding an item 30b, being a written paper letter, different from item 30a, and referring again to FIG. 3, at the third step which is upon placing item 30b onto conveyor 28, scanning cameras 32a, 32b, and 32c scan item 30a, and provide the data to computer 90.

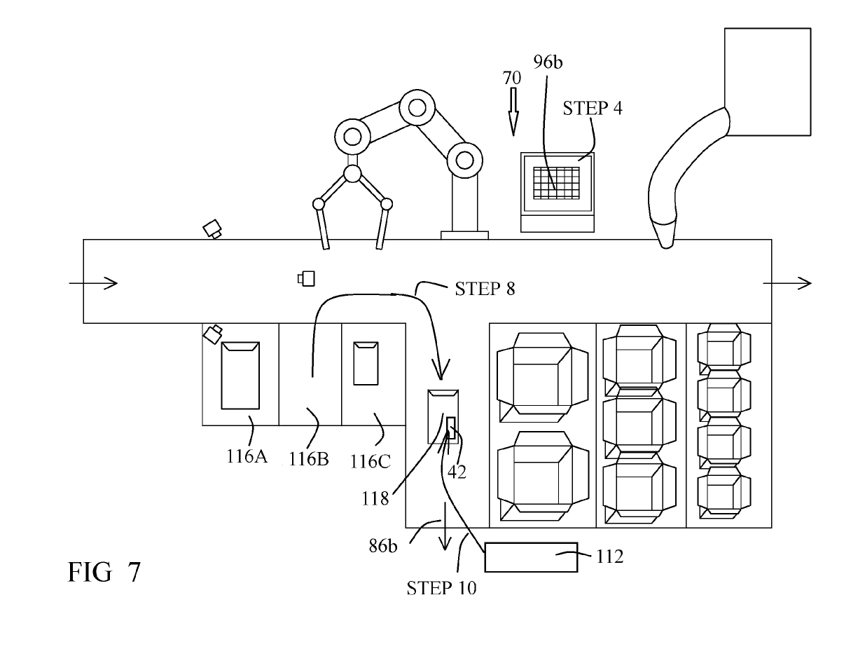

FIG. 7 depicts the next steps of the mechanical operation of the shipment of the other item depicted in FIG. 3.

At the fourth step, computer 90 builds the data from scanners 32a, 32b, and 32c to a three-dimensional model 96b of item 30b.

According to the example of item 30b, computer 90 analyzes the three-dimensional model 96b of item 30b, and accordingly selects a packaging type 80, being an envelope, rather than packaging type 82 of the carton box.

Computer 90 further analyzes the three-dimensional model 96b of item 30b, and accordingly selects the middle sized envelopes compartment 116B, rather than the small envelopes compartment 116A or the large envelopes compartment 116C.

The fifth step, sixth step, and the seventh steps are the same as described regarding item 30a.

At the eighth step and further on, packaging system 70 packages item 30b, as a function of model 96b.

At the eighth step, robotic arm 94 or a different mechanical tool removes an envelope 118 from medium envelopes compartment 116B, and inserts item 30b thereinto. The ninth step regarding to item 30b is not relevant.

At the tenth step, printer 112 or another printer prints the delivery address 42 on envelope 118.

At the eleventh step, conveyor 28 transfers item 30b to a second exit 86b of conveyor 28 for placing it in another location in delivery room 44.

Thus, the invention is directed to self-service terminal (10), including:
a platform (102), for placing an item (30a, 30b) thereon for delivery;
a user interface (12), for inputting delivery data;
at least one sensor (32a) and a computer (90), for reading and analyzing the item (30a, 30b);
self-payment means (104), for allowing paying according to determination of the computer (90); and
a conveyor (28), for transferring the item (30a, 30b) from the platform (102) for delivery, upon making the payment.

The self-service terminal (10) may further include:
a packaging system (70) for packaging the item (30a, 30b),
   wherein the at least one sensor (32a) includes a three-dimensional scanner (78a, 78b, 78c), for providing a three-dimensional model (96a) of the item (30a, 30b), for packaging the item (30a, 30b) as a function of the three-dimensional model (96a).

The self-service terminal (10) may further include:
a packaging system (70) for packaging the item (30a, 30b) as a function of the analysis thereof, thus being capable of packaging by various types.

The packaging of the item (30a, 30b) as a function of the analysis thereof, may include:
packaging according to a packaging type (80, 82), being suitable to a type of the item; and/or
packaging, for providing a size (106A, 106B) being suitable to a type of them item; and/or
packaging, for providing a filling substance, for filling at least one gap (77).

The at least one sensor (32a) may include:
a weight (104), for weighing the item (30a, 30b); and/or
a three-dimensional scanner (78a, 78b, 78c), for providing a three-dimensional model (96a) of the item (30a, 30b).

The self-service terminal (10) may further include:

at least one printer (112), for printing: a receipt (40) for a user, and/or a delivery address (42) to be printed on the item (30a, 30b).

In the figures and/or description herein, the following reference numerals (Reference Signs List) have been mentioned:
numeral 10 denotes delivery terminal, according to one embodiment of the invention;
numeral 12 denotes a user interface, which may include a screen and a keyboard as a touch screen keyboard;
numeral 14 denotes an opening for a printout;
numeral 16a denotes a banknote;
numeral 16b denotes an opening for inserting banknotes;
numeral 18a denotes a credit card;
numeral 18b denotes an opening for inserting a credit card;
numeral 20a denotes a coin;
numeral 20b denotes an opening for inserting coins;
numeral 22 denotes an opening for obtaining signatures;
numeral 24 denotes a rolling door, for opening the cell;
numeral 26 denotes a handle;
numeral 28 denotes a conveyor;
numerals 30a and 30b denote two different exemplary items to be delivered by the terminal;
numerals 32a, 32b, and 32c denote sensors, which may function together as a scanner, for reading contents of the item to be delivered;
numeral 34 denotes the item's measured weight;
numeral 36 denotes the computed price to be paid;
numeral 38 denotes a confirmation statement;
numeral 40 denotes a delivery receipt;
numeral 42 denotes the delivery address, inputted by the user, and then used by the terminal; the delivery address is for being printed on the packaging of the item and on the receipt;
numeral 44 denotes a room for shipping therefrom;
numeral 70 denotes a packaging system, being capable of packaging more than one type of packaging and more than one size, etc.;
numeral 72 denotes the entrance to the conveyor;
numeral 77 denotes a space in the item to be delivered, e.g., the item is a jar having an open volume, which preferably is to be filled for providing safe delivery;
numeral 80 denotes a plurality of compartments, each containing different sized envelopes, for taking out the best sized envelope therefrom; numeral 80 is an example of a packaging type using envelopes;
numeral 82 denotes a plurality of compartments, each containing different sized carton boxed, for taking out the best sized envelope therefrom; numeral 82 is an example of a packaging type using carton boxes;
numeral 86a denotes the exit of the conveyor, for releasing an item being packaged by a first type of packaging, being according to the example, a carton box packaging;
numeral 86b denotes the exit of the conveyor, for releasing an item being packaged by a second type of packaging, being according to the example, an envelope packaging;
numeral 90 denotes a computer;
numeral 92 denotes a polystyrene beads dispenser;
numeral 94 denotes a robotic arm;
numerals 96a and 96b denote two different three-dimensional computerized models of two different items to be delivered;
numeral 102 denotes a cell for placing thereon an item for delivery;
numeral 104 denotes self-payment means;
numerals 106A, 106B and 106C denote compartments containing large, medium and small boxes respectively;
numeral 108 denotes a carton box, selected by the terminal for packaging the item to be delivered;
numeral 110 denotes polystyrene beads for filling gaps;
numeral 118 denotes an envelope, selected by the terminal for packaging the item to be delivered;
numeral 112 denotes a printer for printing delivery data on the package of the item, and on a delivery receipt; and
numerals 116A, 116B and 116C denote compartments containing large, medium and small envelopes respectively.

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

The reference numbers in the claims are not a part of the claims, but rather used for facilitating the reading thereof. These reference numbers should not be interpreted as limiting the claims in any form.

What is claimed is:

1. A self-service terminal, comprising:
a platform, for placing an item thereon for delivery;
a user interface, for inputting delivery data;
at least one sensor and a computer, for reading and analyzing the item;
self-payment means, for allowing paying according to determination of said computer; and
a conveyor, for transferring the item from said platform for delivery, upon making said payment.

2. A self-service terminal according to claim 1, further comprising:
a packaging system for packaging the item,
wherein said at least one sensor comprises a three-dimensional scanner, for providing a three-dimensional model of the item, for packaging the item as a function of said three-dimensional model.

3. A self-service terminal according to claim 1, further comprising:
a packaging system for packaging the item as a function of said analysis thereof.

4. A self-service terminal according to claim 3, wherein said packaging of the item as a function of said analysis thereof, comprises at least one member selected from a group consisting of:
packaging according to a packaging type, being suitable to a type of item;
packaging, for providing a size being suitable to a type of item;
packaging, for providing a filling substance, for filling at least one gap.

5. A self-service terminal according to claim 1, wherein said at least one sensor comprises at least one member selected from a group consisting of:
a weight, for weighing the item;
a three-dimensional scanner, for providing a three-dimensional model of the item.

6. A self-service terminal according to claim 1, further comprising:
at least one printer, for printing at least one member selected from a group consisting of: a receipt for a user, delivery address to be printed on the item.
